(19) United States
(12) Patent Application Publication
(10) Pub. No.: US 2025/0164967 A1
(43) Pub. Date: May 22, 2025

(54) COMPUTER IMPLEMENTED METHOD AND SYSTEM FOR PLANNING PATHS FOR AUTONOMOUS COMPACTION OF WORK AREA

(71) Applicant: Caterpillar Inc., Peoria, IL (US)

(72) Inventor: Gautham Subramanian, Pallikaranai (IN)

(73) Assignee: Caterpillar Inc., Peoria, IL (US)

(21) Appl. No.: 18/516,365

(22) Filed: Nov. 21, 2023

(51) Int. Cl. G05B 19/4155

(52) U.S. Cl. CPC G05B 19/4155; G05B 2219/40069

(57) ABSTRACT

A compaction machine may operate autonomously to travel along defined paths through a work area while compacting the surface of the work area. A worksite controller may generate the paths and assign the compaction machine to follow the paths. The worksite controller may model the shape of the paths through the work area based on the shape of a model edge of the work area, such that the paths may be non-straight if the model edge is not straight. If the model edge bends at angles that exceed a threshold angle, the worksite controller may smoothen the model edge and model that shape of the generated paths based on the smoothened model edge.

### TECHNICAL FIELD

The present disclosure relates to planning paths for an autonomous compaction machine at a worksite and, more particularly, to determining paths for an autonomous compaction machine based on the shape of an edge of a work area.

### BACKGROUND

A compaction machine at a worksite may perform operations to compact a surface of a work area at the worksite. The compaction machine may have a drum compactor, vibrating compactor, or other compaction component that is configured to apply stress to the surface of the work area. Stress applied to the surface of the work area by the compaction machine may cause densification of soil and other materials associated with the surface.

The compaction machine may travel around a work area, such that the compaction machine compacts the surface of different portions of the work area at different times as the compaction machine travels around the work area. For instance, the compaction machine may travel by making different passes back and forth through the work area in order to travel through, and compact the surface of, the entire work area. In some examples, the compaction machine may be an autonomous machine that is configured to travel around, and perform compaction operations at, an assigned work area automatically.

Various systems have been developed in the past to define boundaries of work areas, and to assign machines to perform work operations within those work areas. For example, U.S. Pat. No. 11,236,492 to Ready-Campbell et al. (hereinafter “Ready-Campbell”) describes a system in which a user may use a graphical user interface to manage an autonomous earth shaping vehicle that operates at a worksite. The graphical user interface described by Ready-Campbell allows, for instance, a user to provide input that defines the boundaries of a specific work area at the worksite, that defines paths for an earth shaping vehicle within the work area, and/or that adjusts the boundaries of the work area or the paths in real time based on remote monitoring of operations of the earth shaping vehicle within the work area. Alternately, the system described by Ready-Campbell may automatically generate paths for an earth shaping vehicle based on identifying differences between a current shape of the terrain of the work area and a target shape of the terrain of the work area. An earth shaping vehicle may autonomously follow such user-generated or automatically-generated paths to perform earth shaping operations within defined boundaries of a work area.

Overall, Ready-Campbell focuses on generating and adjusting paths for an earth shaping machine that are expected, by a user or a computing system, to cause the terrain of a work area to match a target shape once the earth shaping machine has completed work at the work area. Accordingly, the system described by Ready-Campbell may generate and/or adjust any number of paths, associated with travel routes of any shape, that may cause the terrain of a work area to match a target shape by the time the earth shaping vehicle completes operations in association with the paths. Ready-Campbell may therefore have limited abilities to minimize or optimize the number of travel paths associated with a defined work area that are automatically generated and assigned to a machine.

Examples of the present disclosure are directed to overcoming the deficiencies noted above.

### SUMMARY

According to a first aspect of the present disclosure, a computer-implemented method includes determining, by a computing system including a processor, boundary points defining boundaries of a work area with a surface to be compacted by a compaction machine. The computer-implemented method also includes determining, by the computing system, edges of the work area based on the boundary points. The computer-implemented method additionally includes selecting, by the computing system, a model edge from among the edges. The computer-implemented method further includes generating, by the computing system, a series of paths positioned at intervals across a width of the work area. Individual paths, of the series of paths, have path shapes modeled after a shape of the model edge. The computer-implemented method also includes sending, by the computing system, compaction instructions defining the series of paths. The compaction instructions cause the compaction machine to autonomously travel along the series of paths while performing compaction operations to compact the surface of the work area.

According to a second aspect of the present disclosure, a computing system includes a processor and a memory having stored thereon computer-executable instructions. The computer-executable instructions, when executed by the processor, cause the processor to determine boundary points defining boundaries of a work area with a surface to be compacted by a compaction machine. The computer-executable instructions, when executed by the processor, also cause the processor to determine edges of the work area based on the boundary points. The computer-executable instructions, when executed by the processor, additionally cause the processor to select a model edge from among the edges. The computer-executable instructions, when executed by the processor, further cause the processor to generate a series of paths positioned at intervals across a width of the work area. Individual paths, of the series of paths, have path shapes modeled after a shape of the model edge. The computer-executable instructions, when executed by the processor, also cause the processor to send compaction instructions defining the series of paths. The compaction instructions cause the compaction machine to autonomously travel along the series of paths while performing compaction operations to compact the surface of the work area.

According to a third aspect of the present disclosure a system includes a compaction machine and a worksite controller associated with a worksite. The compaction machine includes a compaction component configured to perform compaction operations to compact a surface of a work area at the worksite. The compaction machine also includes a wireless communication interface configured to receive compaction instructions defining paths within the work area. The compaction machine additionally includes an electronic control module configured to, based on the compaction instructions, cause the compaction machine to autonomously travel along the paths while the compaction machine performs the compaction operations. The worksite controller includes a processor and a memory having stored thereon computer-executable instructions. The computer-executable instructions, when executed by the processor, cause the processor to determine boundary points defining boundaries of the work area. The computer-executable instructions, when executed by the processor, also cause the processor to determine edges of the work area based on the boundary points, and to select a model edge from among the edges. The computer-executable instructions, when executed by the processor, additionally cause the processor to generate the paths, within the work area, based on a path shape modeled after a shape of the model edge. The computer-executable instructions, when executed by the processor, further cause the worksite controller to send the compaction instructions to the wireless communication interface of the compaction machine.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is an exemplary diagrammatic illustration of a worksite at which a compaction machine operates to compact a surface of a work area.

FIG. 2 shows a first example of paths, associated with a first work area, determined by a worksite controller based on the shape of a model edge of the first work area.

FIG. 3 shows a second example of paths, associated with a second work area, determined by the worksite controller based on the shape of a model edge of the second work area.

FIG. 4 shows a third example of paths, associated with a third work area, determined by the worksite controller based on the shape of a model edge of the third work area.

FIG. 5 shows a fourth example of paths, associated with a fourth work area, determined by the worksite controller based on the shape of a model edge of the fourth work area.

FIG. 6 shows a fifth example of paths, associated with a fifth work area, determined by the worksite controller.

FIG. 7 is a flowchart illustrating an exemplary process for generating paths associated with a work area, and assigning a compaction machine to follow the paths while compacting a surface of the work area.

FIG. 8 is a schematic illustration depicting an exemplary architecture of a computing system that executes one or more elements described in the present disclosure.

### DETAILED DESCRIPTION

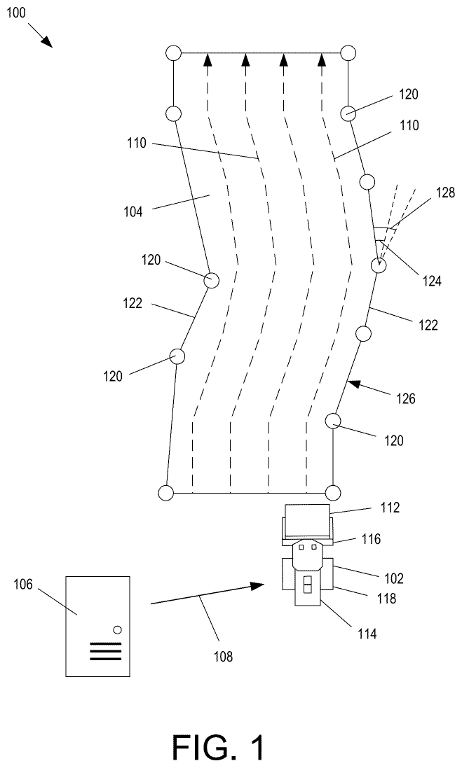

FIG. 1 is an exemplary diagrammatic illustration of a worksite 100 at which a compaction machine 102 operates to compact a surface of a work area 104. The compaction machine 102 may be an autonomous or semi-autonomous machine that is assigned to compact the surface of the work area 104. For example, a worksite controller 106 associated with the worksite 100 may provide compaction instructions 108 that cause the compaction machine 102 to autonomously perform compaction operations to compact the surface of the work area 104. The compaction instructions 108 may assign the compaction machine 102 to the work area 104, and/or may define paths 110 at the work area 104 that the compaction machine 102 may travel along while performing compaction operations to compact the surface of the work area 104.

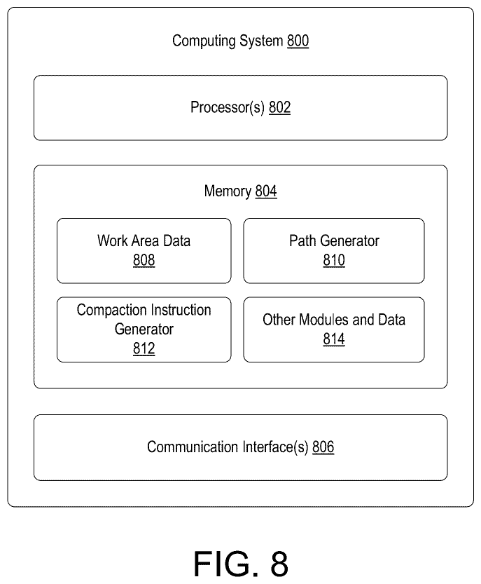

The worksite controller 106 may be a computer-implemented system that executes via one or more servers, computers, or other off-board computing devices or computing systems that are separate from the compaction machine 102. Computing elements that execute the worksite controller 106 may be present on-site at the worksite 100, or may be located at a back office or other location that is remote from the worksite 100. FIG. 8, discussed further below, shows an example system architecture for a computing system that may execute the worksite controller 106.

The worksite 100 may be a mine site, a quarry, a construction site, or any other type of worksite or work environment. The compaction machine 102 may have one or more compaction components 112 that are configured to apply stress to the surface of the work area 104 and cause densification of soil, concrete, asphalt, and/or other materials thereon, and/or to obtain a desired surface finish. The compaction machine 102 may compact the surface of the work area 104 by traveling via different passes, based on corresponding paths 110, through different portions of the work area 104 while performing compaction operations to apply stress to the surface of the work area 104.

The compaction components 112 may include drums, vibrating components, and/or other types of components that may apply stress to the surface of the work area 104. The compaction machine 102 may, for example, be a double drum compacting machine that has a front drum and a back drum. The drums may serve to propel the compacting machine and compact material via the weight of the compaction machine 102 and/or via drum vibrating apparatuses. In other examples, the compaction machine 102 may be a single drum compacting machine, a wheeled or tracked compactor, a vibratory compactor, a tandem vibratory compactor, or any other type of compaction machine 102.

In some examples, other types of machines may operate at the worksite 100 in addition to the compaction machine 102. For instance, a grading machine, such as a scraper, bulldozer, motor grader, or other type of grading machine, may in some situations prepare the work area 104 by performing grading operations to flatten the surface of the work area 104. After the grading machine has flattened the surface of the work area 104, the compaction machine 102 may compact the surface of the work area 104. However, in other examples or situations, the compaction machine 102 may compact the surface of the work area 104 without a grading machine or other machine having previously prepared the work area 104.

The compaction machine 102 may be an autonomous machine or a semi-autonomous machine that may perform travel operations, compaction operations, and/or other types of operations at the worksite 100 automatically. For example, the compaction machine 102 may autonomously travel along paths 110 defined in compaction instructions 108 determined by the worksite controller 106, as described herein. The compaction machine 102 may have an electronic control module (ECM) 114 and/or other on-board computing devices that may cause the compaction machine 102 to perform autonomous or semi-autonomous operations based on compaction instructions 108, sensor data, and/or other data.

The compaction machine 102 may have one or more sensors 116 that measure, collect, or otherwise determine one or more types of sensor data associated with the compaction machine 102 and/or operations performed by the compaction machine 102. For example, the sensors 116 may include cameras, LIDAR sensors, RADAR sensors, other optical sensors or perception systems, Global Positioning System (GPS) sensors, other location and/or positioning sensors, incline and decline travel sensors, speed sensors, temperature sensors, tire pressure sensors, battery state of health (SoH) sensors, battery state of charge (SoC) sensors, fuel sensors, and/or other types of sensors.

Such sensors 116 of the compaction machine 102 may be operably coupled to the ECM 114 and/or other on-board computing systems of the compaction machine 102, and may provide corresponding sensor data to the ECM 114 and/or other on-board computing systems of the compaction machine 102. Sensor data provided by sensors 116 may, in some examples, enable the ECM 114 of the compaction machine 102 to cause the compaction machine 102 to drive and/or operate autonomously or semi-autonomously. For instance, location data and/or other types of sensor data captured by one or more sensors 116 may allow the ECM 114 to cause the compaction machine 102 to autonomously follow and travel along paths 110 defined in compaction instructions 108 received from the worksite controller 106.

The compaction machine 102 may have wireless communication interfaces 118 that are operably coupled to the ECM 114 and/or other on-board computing systems of the compaction machine 102. The wireless communication interfaces 118 may be, or include, cellular interfaces, Wi-Fi® interfaces, Bluetooth® interfaces, machine-to-machine data interfaces, peer-to-peer data interfaces, and/or other types of wireless communication interfaces. For example, the wireless communication interfaces 118 may include one or more modems, receivers, transmitters, antennas, and/or other hardware or software elements configured to send and/or receive data. The worksite controller 106 may have similar wireless communication interfaces, and/or wired communication interfaces, such that the worksite controller 106 may exchange data with the ECM 114 of the compaction machine 102.

The wireless communication interfaces 118 may allow the ECM 114 and/or other on-board computing systems of the compaction machine 102 to exchange data with the worksite controller 106, for instance by receiving data from the worksite controller 106 and/or transmitting data to the worksite controller 106. The wireless communication interfaces 118 of the compaction machine 102 may, for example, receive compaction instructions 108 transmitted by the worksite controller 106, and may provide the received compaction instructions 108 to the ECM 114.

The worksite controller 106 may store, maintain, and/or access information associated with the worksite 100 and/or the compaction machine 102. For example, the worksite controller 106 may have information defining the location and/or boundaries of the worksite 100, a location of the compaction machine 102, locations of other machines and/or other elements at the worksite 100, a type of the worksite 100, a map of the worksite 100, information about the terrain of the worksite 100, information about textures, densities, and/or other attributes of soil or other material at the worksite 100, weather information associated with the compaction machine 102, and/or other information about the worksite 100. The worksite controller 106 may also have information about the compaction machine 102, such as information defining a type of the compaction machine 102, capabilities of the compaction machine 102 and/or the compaction components 112 of the compaction machine 102, a configuration of the compaction machine 102, a physics model of the compaction machine 102, and/or other information about the compaction machine 102.

The information about the worksite 100, maintained by and/or accessible by the worksite controller 106, may include data that defines edges of the work area 104. For example, the worksite controller 106 may have, and/or may access, data indicating locations of boundary points 120 associated with the work area 104. The locations of the boundary points 120 may have been defined by a user of the worksite controller 106, may be defined within a work area definition that has been provided by an owner or operator of the worksite 100, or may be defined by any other data that is stored by, maintained by, and/or is accessible by the worksite controller 106. The boundary points 120 may define a geofence or other border of the work area 104.

Edges of the work area 104 may accordingly include segments 122 that each span between defined locations of two boundary points 120. For example, an edge of the work area 104 may be associated with two or more boundary points 120, and may include one or more segments 122 that span between the boundary points 120. In some examples, an edge of the work area 104 may have multiple segments 122 that span between a series of boundary points 120 along that edge, such that those boundary points 120 may include midpoints along the edge. Edges of the work area 104 may also meet at boundary points 120 located at corners of the work area 104, such that some boundary points 120 may be endpoints of edges and may join those edges with other edges.

In some examples, the boundary points 120 may not be pre-associated with corresponding edges of the work area 104. However, the worksite controller 106 may identify which boundary points 120 represent corners of the work area 104, and are thus endpoints of corresponding edges of the work area 104, by identifying boundary points that join segments 122 aligned along directions that have the largest differences. For example, as discussed further below, the worksite controller 106 may determine directions along which individual segments 122, between pairs of boundary points 120, are oriented. The worksite controller 106 may also determine difference angles 124 between directions of segments 122 that meet at corresponding boundary points 120. The worksite controller 106 may identify the boundary points 120 that are associated with the largest difference angles 124 as corner points of the work area 104, and thereby determine that distinct edges of the work area 104 terminate, and meet, at the identified corner boundary points 120. For example, the worksite controller 106 may be configured to consider the boundary points 120 with the four largest difference angles 124 as four corner points of the work area 104 where four distinct edges of the work area 104 meet.

The worksite controller 106 may determine the shapes and positions of the paths 110, within the work area 104, that the compaction machine 102 is assigned to follow. The worksite controller 106 may also generate and send compaction instructions 108 that cause the compaction machine 102 to autonomously or semi-autonomously travel along the paths 110, determined by the worksite controller 106, while performing compaction operations. For example, the compaction instructions 108 may define a locations of the boundary points 120 surrounding the work area 104 to which the compaction machine 102 is assigned, serving as a geofence around the work area 104. The compaction instructions 108 may also define geofences or other location data associated with locations along the defined paths 110, such that the compaction machine 102 may travel along the defined paths 110 based on corresponding location information in the compaction instructions 108.

As shown in FIG. 1, the paths 110 determined by the worksite controller 106 may have identical or substantially identical shapes, and may be spaced apart at intervals spanning from one edge of the work area 104 to an opposite edge of the work area 104. Accordingly, the compaction machine 102 may travel along a first path 110 to make a first pass through a first portion of the work area 104, travel along a second path 110 that has the same shape as the first path 110 and is adjacent to the first path 110 to make a second pass through a second portion of the work area 104, and continue traveling along subsequent adjacent paths 110 through remaining portions of the work area 104.

The compaction machine 102 may travel along one path 110, and then exit the work area 104 to reposition the compaction machine 102 to travel along the next adjacent path 110. For example, the compaction machine 102 may exit the work area 104 after completing travel along a first path 110, such that the compaction machine 102 may back up, turn, and/or perform other repositioning maneuvers to re-align the compaction machine 102 with an adjacent second path 110 before then entering the work area 104 again to travel along the second path 110.

In some examples, the compaction machine 102 may perform repositioning maneuvers at a single end of the work area 104 to prepare for travel along paths 110. As an example, the compaction machine 102 may travel forward in a substantially northerly direction along a first path 110, reverse and travel backwards in a substantially southerly direction along the same first path 110, exit the first path 110 from a south end of the work area 104 while in reverse, and perform turning maneuvers in reverse and/or while traveling forward again to become in alignment with a second path 110 that is adjacent to the first path 110. The compaction machine 102 may then travel forward again in a substantially northerly direction along the second path 110, reverse and travel backwards in a substantially southerly direction along the same second path 110, exit the second path 110 from a south end of the work area 104 while in reverse, and perform turning maneuvers in reverse and/or while traveling forward again to become in alignment with a third path 110 that the compaction machine 102 is to travel along next.

In other examples, the compaction machine 102 may perform repositioning maneuvers at opposite ends of the work area 104 to prepare for travel along paths 110. As an example, the compaction machine 102 may travel in a substantially northerly direction along a first path 110, exit the first path 110 from a north end of the work area 104, turn around to face south and be in alignment with a second path 110, travel in a substantially southerly direction along the second path 110, exit the second path 110 from a south end of the work area 104, and turn around again to face north and be in alignment with a third path 110 that the compaction machine 102 is to travel along next.

As discussed above, the paths 110 may be spaced apart at intervals across a width of the work area 104, but may each have an identical shape. The worksite controller 106 may determine the shape of the paths 110 based at least in part on the shape of one of the edges of the work area 104. For instance, the worksite controller 106 may use one of the edges of the work area 104 as a model edge 126, and determine the shape of the paths 110 based on the shape of the model edge 126.

In some examples, the worksite controller 106 may determine which of the edges of the work area 104 to use as the model edge 126 by using the locations of defined boundary points 120 to identify an edge of the work area 104 that is relatively long and smooth, as discussed further below.

For example, the worksite controller 106 may identify distinct edges based on the defined boundary points 120 associated with the work area 104. As discussed above, boundary points 120 may be defined as, or may be determined to be, endpoints or midpoints of corresponding edges. The worksite controller 106 may also use the locations of the boundary points 120 associated with each edge to determine corresponding segments 122 that span between the boundary points 120. The worksite controller 106 may determine the overall length of each edge by totaling the lengths of the individual segments 122 of each edge. The worksite controller 106 may accordingly determine the relative lengths of each edge, for instance by determining which edges are shorter than other edges and which edges are longer than other edges.

The worksite controller 106 may identify edges that may be candidates for the model edge 126 based on the lengths of the edges, such as by identifying edges of the work area 104 that are longer than other edges. For example, the worksite controller 106 may be configured to identify the two longest edges of the work area 104 as candidates to be the model edge 126.

In some examples, the worksite controller 106 may determine that one or more other edges of the work area 104, such as shorter edges that are not candidates to be the model edge 126, may be edges at which paths 110 start and/or stop. For example, the compaction machine 102 may exit and/or enter the work area 104 in association with paths 110 at those edges, and perform turning maneuvers outside the work area 104 proximate to those edges to realign the compaction machine 102 with next paths 110 to be traveled. In some examples, the worksite controller 106 may identify one or more of the edges, that are not candidates to be the model edge 126, as edges where the compaction machine 102 may perform turning maneuvers based on identifying that areas proximate to those edges are clear of obstacles, operations of other machines, and/or are otherwise suited for the compaction machine 102 to perform turning maneuvers.

After identifying which edges of the work area 104 are candidates to be the model edge 126, the worksite controller 106 may select one of those edges as the model edge 126 by determining which of the candidate model edges is the smoothest. The worksite controller 106 may evaluate the smoothness of a candidate model edge by determining directions along which individual segments 122 of the candidate model edge are oriented, determining difference angles 124 between adjacent segments 122 of the candidate model edge that meet at corresponding boundary points 120, and determining which of the candidate model edges is the smoothest and should be used as the model edge 126 based on the difference angles 124 associated with the boundary points 120 of the candidate model edges.

For instance, the worksite controller 106 may identify directions along which individual segments 122 of an edge are oriented, such as relative to a north-south directional axis or any other reference direction. The worksite controller 106 may also determine difference angles 124 between the directions of adjacent segments 122 of the edge, such as segments 122 that join at a particular boundary point 120 along the edge. For example, the worksite controller 106 may identify a first segment 122 of an edge spanning between a first boundary point 120 on the edge and a second boundary point 120 on the edge, and may identify a second segment 122 of the edge spanning between the second boundary point 120 on the edge and a third boundary point 120 on the edge. The worksite controller 106 may identify directions along with the first segment 122 and the second segment 122 are oriented, and may identify a difference angle 124 between the directions associated with the first segment 122 and the second segment 122.

The worksite controller 106 may, in some examples, determine a difference angle 124 associated with two adjacent segments 122 of an edge that meet at a particular boundary point 120, and compare that difference angle 124 with a threshold angle 128 to determine whether the difference angle 124 is greater than the threshold angle 128. The threshold angle 128 may be a preset value that is configured by a user of the worksite controller 106, and/or that may be based on an operational turning radius of the compaction machine 102. The operational turning radius of the compaction machine 102 may be a maximum angle at which the compaction machine 102 is configured to turn while traveling and while performing compaction operations via the compaction components 112. As an example, if the compaction machine 102 is able to perform compaction operations while traveling and turning at angles of fifteen degrees or less, the threshold angle 128 may be set at fifteen degrees. Accordingly, in this example, the worksite controller 106 may determine whether adjacent segments 122 that join at boundary points 120 are oriented along directions that differ by difference angles 124 that are greater than the threshold angle 128 of fifteen degrees. In other examples, the threshold angle 128 may be a higher or lower value, and/or may be a configurable value that is set by a user of the worksite controller 106 or that is based on other data.

In some examples, the worksite controller 106 may evaluate segments 122 of different candidate model edges, determine a sum or other overall measure of the difference angles 124 associated with the boundary points 120 of each of the candidate model edges. In these examples, the worksite controller 106 may determine which of the candidate model edges is the smoothest, and should be used as the model edge 126, based on determining which of the candidate model edges is associated with the lowest overall difference angle 124.

In other examples, the worksite controller 106 may determine how many boundary points 120 along each of the candidate model edges are associated with difference angles 124 that are greater than the threshold angle 128. In these examples, the worksite controller 106 may determine which of the candidate model edges is the smoothest, and should be used as the model edge 126, based on determining which of the candidate model edges has the lowest number of boundary points 120 associated with difference angles 124 that exceed the threshold angle 128.

As a non-limiting example, the worksite controller 106 may evaluate the boundary points 120 shown in FIG. 1, and determine that the edges on the left and right sides of the work area 104 are the longest and may therefore be considered candidate model edges. The worksite controller 106 may determine that the left edge of the work area 104 has sharper bends than the right edge of the work area 104, for instance because the segments 122 of the right edge are associated with a lower overall difference angle 124 and/or has fewer boundary points 120 associated with difference angles 124 greater than the threshold angle 128. Accordingly, the worksite controller 106 may determine that the right edge of the work area 104 is smoother than the left edge of the work area 104 and should be used as the model edge 126 for the shape of the paths 110.

In some situations, the worksite controller 106 may determine that two candidate model edges are equally smooth and could serve as the model edge 126, for instance because the two candidate model edges are associated with the same overall difference angle 124 and/or have the same number of boundary points 120 associated with difference angles 124 that exceed the threshold angle 128. In these situations, the worksite controller 106 may select either of the two candidate model edges to be the model edge 126.

After determining which of the edges of the work area 104 to use as the model edge 126, the worksite controller 106 may determine the shape of the paths 110 based on the shape of the model edge 126. If the difference angles 124 of all of the boundary points 120 on the identified model edge 126 are less than or equal to the threshold angle 128, the compaction machine 102 may be able to navigate paths 110 that have the same shape as the model edge 126. As an example, if the compaction machine 102 has an operational turning radius of 15 degrees, and the difference angles 124 associated with all of the boundary points 120 in the model edge 126 are less than or equal to 15 degrees, the compaction machine 102 may be able to travel along paths 110 that have the same shape as the model edge 126 because the paths 110 would not require the compaction machine 102 to make any turns greater than 15 degrees while performing compaction operations. The worksite controller 106 may accordingly define paths 110 that have the same shape as the model edge 126 and that are spaced at predefined intervals across a width of the work area 104 from the model edge 126 to the opposite edge of the work area 104.

If difference angles 124 of one or more of the boundary points 120 on the identified model edge 126 are greater than the threshold angle 128, paths 110 matching the shape of the model edge 126 may have turns that exceed the threshold angle 128 and that may not be navigable by the compaction machine 102 during performance of compaction operations. As an example, if the compaction machine 102 has an operational turning radius of 15 degrees, and the difference angles 124 associated with one or more of the boundary points 120 in the model edge 126 are greater than 15 degrees, the compaction machine 102 may not be able to travel along paths 110 that have the same shape as the model edge 126 because the paths 110 would require the compaction machine 102 to make turns greater than 15 degrees while performing compaction operations.

However, in this situation, the worksite controller 106 may be configured to smoothen the model edge 126 by, for example, automatically adding and/or moving boundary points 120 to add and/or adjust segments 122 of the model edge 126 such that difference angles 124 associated with the segments 122 of the smoothened model edge 126 do not exceed the threshold angle 128. The worksite controller 106 may add and/or move boundary points 120 associated with the model edge 126 such that the adjusted smoothened boundaries of the work area 104 are outside of, and encompass, the original unmodified boundaries of the work area 104.

In some examples, the worksite controller 106 may smoothen the model edge 126 by identifying a rate of change in the difference angles 124 associated with a series of boundary points 120 along a portion of the model edge 126 that includes a boundary point 120 with a difference angle 124 that exceeds the threshold angle 128. If the rate of change of the difference angles 124 of boundary points 120 along the portion of the model edge 126 is relatively low, for instance less than a first threshold, the worksite controller 106 may smoothen the model edge 126 by adding or adjusting boundary points 120 along the portion of the model edge 126 that are relatively far away from the boundary point 120 that has the difference angle 124 that exceeds the threshold angle 128. However, if the rate of change of the difference angles 124 of boundary points 120 along the portion of the model edge 126 is relatively high, for instance higher than a first threshold or a second threshold, the worksite controller 106 may smoothen the model edge 126 by adding or adjusting boundary points 120 throughout the portion of the model edge 126.

By smoothing one or more portions of the model edge 126 such that the difference angles 124 of all of the boundary points 120 on the smoothened model edge 126 are less than or equal to the threshold angle 128, the compaction machine 102 may be able to navigate paths 110 that have the same shape as the smoothened model edge 126. For example, if the compaction machine 102 has an operational turning radius of 15 degrees, and the difference angles 124 associated with one or more of the original boundary points 120 in the model edge 126 were greater than 15 degrees, the worksite controller 106 may add and/or adjust boundary points 120 in the model edge 126 to cause difference angles 124 associated with all of the boundary points 120 in the model edge 126 to be less than equal to 15 degrees. Accordingly, the compaction machine 102 may be able to travel along paths 110 that have the same shape as the smoothened model edge 126 because the paths 110 would not require the compaction machine 102 to make any turns greater than 15 degrees while performing compaction operations. The worksite controller 106 may accordingly define paths 110 that have the same shape as the smoothened model edge 126 and that are spaced at predefined intervals across a width of the work area 104 from the smoothened model edge 126 to the opposite edge of the work area 104.

In some examples, the work area 104 may not have multiple distinct defined edges. For instance, an analysis of the boundary points 120 and/or the difference angles 124 associated with adjacent segments 122 between the boundary points 120 may indicate that the work area 104 has a single edge with a polygonal shape that substantially encircles the work area 104. In these examples, the worksite controller 106 may use the single edge as the model edge 126. The worksite controller 106 may also determine that the difference angles 124 between all pairs of segments 122 on the model edge 126 may be less than the threshold angle 128, and/or may smoothen the model edge 126 by adding and/or adjust boundary points 120 to cause the difference angles 124 between all pairs of segments 122 on the model edge 126 to be less than the threshold angle 128. In these examples, the worksite controller 106 may accordingly define one or more paths 110 that are based on the shape as the original or smoothened model edge 126. For example, the worksite controller 106 may generate substantially circular paths 110 that mimic the circular model edge 126 of the work area 104 as shown in FIG. 5, or a path 110 formed as a swirl between a center point of the work area 104 and a point on the model edge 126. In other examples, the worksite controller 106 may determine that none of the edges of the work area 104 may be considered to be a model edge 126, and may fall back to generating parallel straight paths 110 that pass through portions of the work area 104, as shown in FIG. 6.

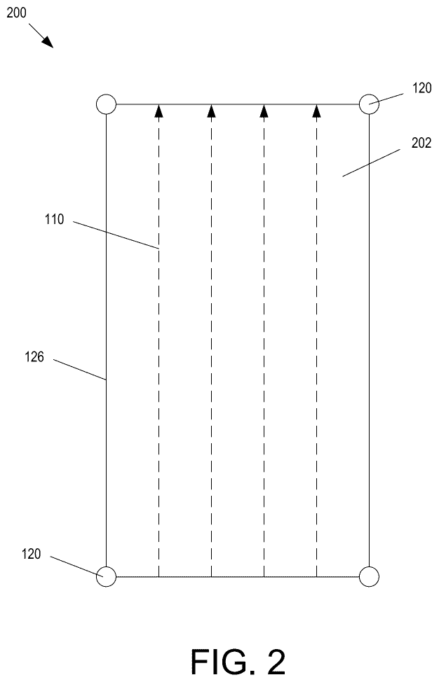

Overall, the worksite controller 106 may determine the shape of the paths 110 based on the shape of the model edge 126. If the model edge 126 is straight and/or has bends associated with difference angles 124 that are less than or equal to the threshold angle 128, the worksite controller 106 may determine the shape of the paths 110 based on the original shape of the model edge 126. If the model edge 126 has one or more bends associated with difference angles 124 that are greater than the threshold angle 128, the worksite controller 106 may modify the shape of the model edge 126 to smoothen those bends, to cause the model edge 126 to have bends associated with difference angles 124 that are less than or equal to the threshold angle 128. Examples of paths 110 determined by the worksite controller 106 based on the shape of the model edge 126 are shown in FIGS. 2-6 and are discussed further below with respect to those figures.

The worksite controller 106 may also generate compaction instructions 108 that identify the paths 110 determined by the worksite controller 106. The worksite controller 106 may transmit the compaction instructions 108 to the wireless communication interfaces 118 of the compaction machine 102. Accordingly, the ECM 114 of the compaction machine 102 may, based on the compaction instructions 108, cause the compaction machine 102 to autonomously or semi-autonomously follow the paths 110 determined by the worksite controller 106 while the compaction machine 102 performs compaction operations at the work area 104.

FIG. 2 shows a first example 200 of paths 110 associated with a first work area 202, determined by the worksite controller 106 based on the shape of a model edge 126 of the first work area 202. In this example, the model edge 126 of the first work area 202 may be straight. For instance, the shape of the first work area 202 may be a rectangle, square, or other regular shape that has a straight edge with at least a threshold length. In this example, the worksite controller 106 may determine that one of the longer straight edges of the rectangular first work area 202 is the model edge 126, and may generate paths 110 following straight lines that mirror the straight model edge 126 of the first work area 202. Accordingly, the worksite controller 106 may generate paths 110 for the compaction machine 102 as a series of parallel straight lines that are spaced apart by intervals across a width of the first work area 202.

Although in some examples the worksite controller 106 may be configured to determine the paths 110 associated with the first work area 202 based on identifying the model edge 126 of the first work area 202, in other examples the worksite controller 106 may be configured to use a predefined direction to generate the paths 110 if the worksite controller 106 determines that the shape of the first work area 202 is a rectangle or other regular shape. For example, if the worksite controller 106 determines that the shape of the first work area 202 is an elongated rectangle that has a length extending along a north-south directional axis, the worksite controller 106 may be configured to generate paths 110 for the compaction machine 102 as a predefined series of parallel straight lines that extend along the north-south directional axis and are spaced apart by intervals across a width of the rectangular first work area 202, without evaluating the edges of the first work area 202 to identify a model edge 126 to use to determine the shape of the paths 110.

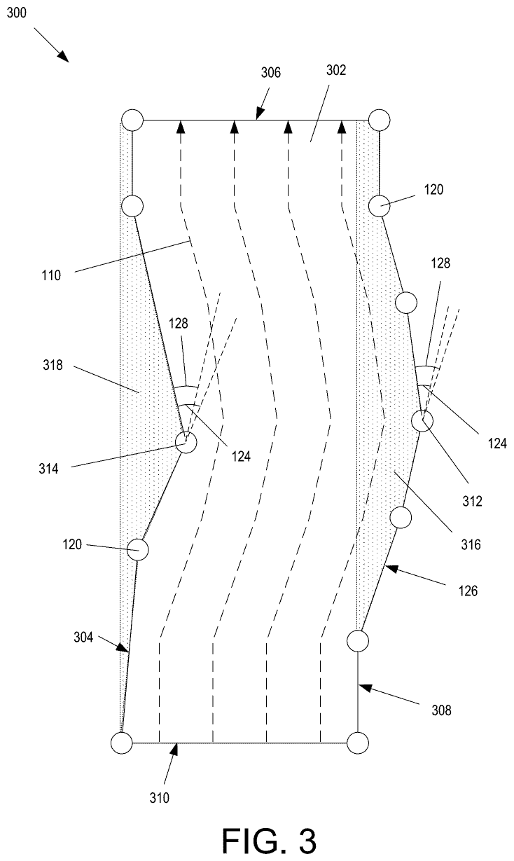

In the example 200 shown in FIG. 2, the shape of the first work area 202 may be a rectangle or other polygon with a straight edge, such that the paths 110 may be parallel straight lines. However, if a work area 104 is shaped as an irregular polygon such that paths 110 oriented along parallel straight lines may cause the compaction machine 102 to miss and not compact portions of the work area 104 and/or travel for a significant period of time outside the boundaries of the work area 104 while traveling along such parallel straight paths 110, the worksite controller 106 may instead generate non-straight paths 110 that have shapes based on the shape of an original or modified non-straight model edge 126 of the work area 104, as discussed further below with respect to FIGS. 3-5.

FIG. 3 shows a second example 300 of paths 110, associated with a second work area 302, determined by the worksite controller 106 based on the shape of a model edge 126 of the second work area 302. In this example, the overall shape of the second work area 302 may be irregular, and the model edge 126 of the second work area 302 may have bends instead of being straight. The worksite controller 106 may identify the which of the edges of the second work area 302 to use as the model edge 126 based on boundary points 120 that define boundaries of the second work area 302.

For example, the worksite controller 106 may use boundary points 120 associated with the second work area 302 to identify edges of the second work area 302, such as a first edge 304, a second edge 306, a third edge 308, and a fourth edge 310. The worksite controller 106 may determine that the second edge 306 and the fourth edge 310 are shorter than the first edge 304 and the third edge 308, and thereby determine that the first edge 304 and the third edge 308 are longer edges of the second work area 302 that are candidates to be selected as the model edge 126 of the second work area 302.

After determining that the first edge 304 and the third edge 308 are candidate model edges, the worksite controller 106 may determine which of the first edge 304 and the third edge 308 is smoother, and should therefore be selected as the model edge 126 of the second work area 302. As shown in FIG. 3, the worksite controller 106 may select the third edge 308 to be the model edge 126 because the third edge 308 is smoother than the first edge 304.

In the second example 300 shown in FIG. 3, the worksite controller 106 may determine that the third edge 308 is smoother than the first edge 304 by determining difference angles 124 associated with boundary points 120 along the first edge 304 and the third edge 308. The worksite controller 106 may determine the difference angle 124 associated with a particular boundary point 120 by determining a difference between directions along which segments 122, joined at the particular boundary point 120, are oriented.

The worksite controller 106 may determine that the third edge 308 is smoother than the first edge 304 by determining that a first overall difference angle 124, associated with all of the difference angles 124 of boundary points 120 along the third edge 308, is lower than a second overall difference angle 124 associated with the difference angles 124 of boundary points 120 along the first edge 304. The worksite controller 106 may also, or alternately, determine that the third edge 308 is smoother than the first edge 304 by determining that the third edge 308 has fewer boundary points 120 that are associated with difference angles 124 that exceed the threshold angle 128 than the first edge 304.

For example, the third edge 308 may have zero boundary points 120 associated with difference angles 124 that exceed the threshold angle 128. For instance, a first boundary point 312 on the third edge 308 may be associated with the largest difference angle 124 of any of the boundary points 120 on the third edge 308. However, the difference angle 124 associated with the first boundary point 312 may be less than the threshold angle 128, such that none of the boundary points 120 on the third edge 308 are associated with difference angles 124 that exceed the threshold angle 128. However, the first edge 304 may have one or more boundary points 120 associated with difference angles 124 that exceed the threshold angle 128. For instance, a second boundary point 314 on the first edge 304 may be associated with a difference angle 124 that exceeds the threshold angle 128. Accordingly, because the third edge 308 has fewer boundary points 120 associated with difference angles 124 that exceed the threshold angle 128 than the first edge 304, the worksite controller 106 may consider the third edge 308 to be smoother than the first edge 304, and may thereby determine to use the third edge 308 as the model edge 126 for the second work area 302.

In the second example 300 shown in FIG. 3, the worksite controller 106 may determine to use the original unmodified shape of the third edge 308, selected as the model edge 126, to generate paths 110 associated with the second work area 302 because none of the none of the boundary points 120 on the third edge 308 are associated with difference angles 124 that exceed the threshold angle 128. Accordingly, because none of the boundary points 120 on the selected model edge 126 are associated with difference angles 124 that exceed the threshold angle 128 in the second example 300 shown in FIG. 3, the worksite controller 106 may avoid smoothing the model edge 126. The worksite controller 106 may thus define paths 110 that have the same shape as the original shape of the third edge 308, selected as the model edge 126 for the second work area 302. The worksite controller 106 may position the paths 110 at predefined intervals across a width of the work area 104, for instance at predefined intervals spanning across from the third edge 308 to the first edge 304.

Overall, because the shape of the paths 110 for the second work area 302 may be based on the shape of the third edge 308, selected as the model edge 126, the paths 110 may each have a relatively smooth shape that is modeled after the shape of the third edge 308. Straight parallel paths 110, similar to the paths 110 shown in FIG. 2, may have potentially caused the compaction machine 102 to miss traveling through and compacting the surface of an outcropping 316 of the second work area 302, and may have potentially caused the compaction machine 102 to travel through an external area 318 outside the second work area 302. However, the non-straight paths 110, modeled after the shape of the third edge 308 that is selected as the model edge 126, may cause the compaction machine 102 to travel through and compact the surface of the outcropping 316 of the second work area 302, and may cause the compaction machine 102 to avoid traveling through the external area 318 that is outside the second work area 302.

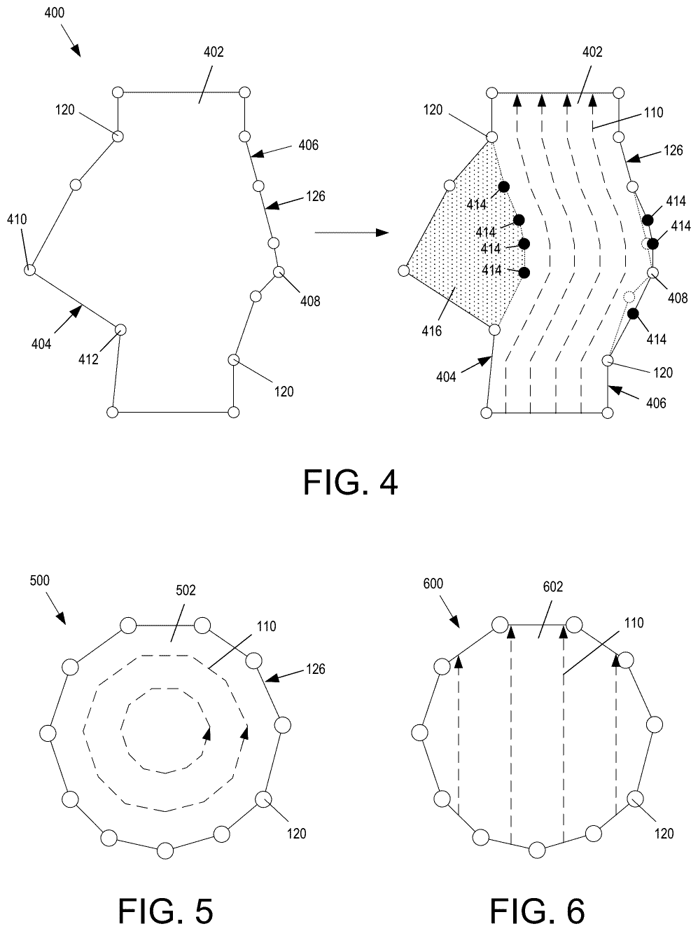

FIG. 4 shows a third example 400 of paths 110, associated with a third work area 402, determined by the worksite controller 106 based on the shape of a model edge 126 of the third work area 402. In this example, the overall shape of the third work area 402 may be irregular, and the model edge 126 of the third work area 402 may have bends instead of being straight. The worksite controller 106 may identify the which of the edges of the third work area 402 to use as the model edge 126 based on boundary points 120 that define boundaries of the third work area 402.

For example, the worksite controller 106 may use boundary points 120 associated with the third work area 402 to identify edges of the third work area 402, similar to identification of edges the second work area 302 discussed above with respect to FIG. 3. The worksite controller 106 may also determine lengths of the identified edges, and determine that longer edges are candidates to be selected as the model edge 126 of the third work area 402. For instance, the worksite controller may determine that a first edge 404 and an opposing second edge 406 of the third work area 402 are longer than other edges of the third work area 402, and are therefore candidates to be selected as the model edge 126 for the third work area 402. The worksite controller 106 may also determine which of the candidate model edges is smoother, and should therefore be selected as the model edge 126 of the third work area 402.

As shown in FIG. 4, the worksite controller 106 may select the second edge 406 to be the model edge 126 because the second edge 406 is smoother than the first edge 404. In this example, the second edge 406 of the third work area 402 may have one or more relatively sharp bends that may be associated with difference angles 124 that exceed the threshold angle 128, for instance at a first boundary point 408 on the second edge 406. However, the first edge 404 may have even sharper bends and/or more sharp bends than the second edge 406, for instance at a second boundary point 410 and a third boundary point 412 on the first edge 404. Accordingly, because the boundary points 120 along the second edge 406 may be associated with a lower overall difference angle 124 than the boundary points 120 along the first edge 404, and/or because the second edge 406 has fewer boundary points 120 associated with difference angles 124 that exceed the threshold angle 128 than the first edge 404, the worksite controller 106 may determine that the second edge 406 is smoother than the first edge 404. The worksite controller 106 may accordingly select the second edge 406 as the model edge 126 for the third work area 402.

However, although the second edge 406 may be selected as the model edge 126 because it is smoother than the first edge 404, the second edge 406 may nevertheless have one or more boundary points 120 that are associated with difference angles 124 that exceed the threshold angle 128. For example, as discussed above, the first boundary point 408 on the second edge 406 may be associated with a difference angle 124 that exceeds the threshold angle 128. Accordingly, in this example, the worksite controller 106 may smoothen the model edge 126 by adding and/or adjusting boundary points 120 along the model edge 126 such that all of the boundary points 120 along the model edge 126 are, or become, associated with difference angles 124 that are less than or equal to the threshold angle 128. For instance, FIG. 4 shows a set of adjusted boundary points 414 along the model edge 126 that the worksite controller 106 may add and/or move, relative to original boundary points 120 along the original second edge 406, to smoothen the model edge 126.

In the third example 400 shown in FIG. 4, the worksite controller 106 may determine to use the smoothened shape of the second edge 406, selected as the model edge 126, to generate paths 110 associated with the third work area 402. The worksite controller 106 may accordingly define paths 110 that have the same shape as the smoothened shape of the model edge 126 for the third work area 402. The worksite controller 106 may position the paths 110 at predefined intervals across a width of the work area 104, for instance at predefined intervals spanning across from the second edge 406 towards the first edge 404.

In some examples, paths 110 shaped based on an original or smoothened model edge 126 of a work area 104 may lead to the paths 110 not allowing the compaction machine 102 to compact the surface of the entire work area 104. For instance, in the third example 400 shown in FIG. 4, non-straight paths 110 shaped based on the shape of the smoothened second edge 406 may not pass through an outcropping 416 of the third work area 402 on or along the first edge 404.

However, in this situation, if paths 110 generated based on the original or smoothened shape of a selected model edge 126 would cause the compaction machine 102 to miss compacting the surface of a portion of a work area 104, the worksite controller 106 may separate that portion into a distinct separate work area 104 so that the worksite controller 106 may determine a distinct set of paths 110 for the separated portion of the work area. For instance, in the third example 400 shown in FIG. 4, the worksite controller 106 may separate the outcropping 416 from the third work area 402 into a different work area 104. The worksite controller 106 may separate the outcropping 416 by adding and/or moving adjusted boundary points 414 on the first edge 404, for instance based on the shape of the paths 110. The worksite controller 106 may evaluate the separated outcropping 416 as a distinct work area 104, and may generate paths 110 associated with the outcropping 416 that may have different shapes and/or directions than the paths 110 generated for the third work area 402.

FIG. 5 shows a fourth example 500 of paths 110, associated with a fourth work area 502, determined by the worksite controller 106 based on the shape of a model edge 126 of the fourth work area 502. In this example, all of the boundary points 120 associated with the fourth work area 502 may be associated with difference angles 124 that do not exceed the threshold angle 128. Accordingly, the fourth work area 502 may be substantially circular and/or be surrounded by a single polygonal edge that does not have bends with difference angles 124 that exceed the threshold angle 128. The worksite controller 106 may accordingly use the single edge of the fourth work area 502 as a model edge 126.

In this example, the worksite controller 106 may generate paths 110 shaped based on the shape of the model edge 126 of the fourth work area 502, such as paths 110 that are substantially circular as shown in FIG. 4. The substantially circular paths 110 may be spaced at intervals away from the model edge 126 of the fourth work area 502, for instance by being formed as concentric paths 110. Because the model edge 126 in this example does not have bends with difference angles 124 that exceed the threshold angle 128, the paths 110 shaped based on the shape of the model edge 126 may also not have bends with difference angles 124 that exceed the threshold angle 128. However, if the overall size of the work area 104 may prevent concentric paths 110 from being generated that do not have bends with difference angles 124 that exceed the threshold angle 128, the worksite controller 106 may use an alternate procedure for generating paths 110, such as by generating straight paths 110 as shown in FIG. 6.

FIG. 6 shows a fifth example 600 of paths 110, associated with a fifth work area 602, determined by the worksite controller 106. In this example, the fifth work area 602 may have a shape similar to the fourth work area 502 shown in FIG. 5. However, the overall size of the fifth work area 602 may be relatively small, such that generating concentric paths 110 based on the shape of the outer edge of the work area 104 as discussed above with respect to FIG. 5 may result in paths 110 that bend at angles that exceed the threshold angle 128. In this situation, the worksite controller 106 may fall back to, or otherwise, use a different procedure for generating paths 110, such as by generating a series of straight paths 110 separated by predefined intervals as discussed above with respect to FIG. 2.

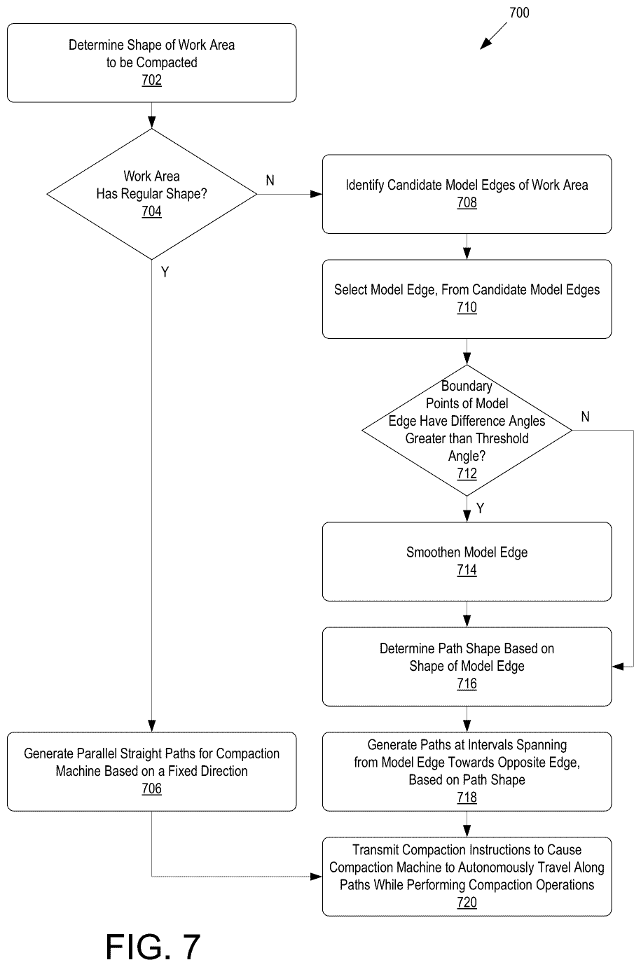

FIG. 7 is a flowchart 700 illustrating an exemplary process for generating paths 110 associated with a work area 104, and assigning a compaction machine 102 to follow the paths 110 while compacting a surface of the work area 104. The operations shown in FIG. 7 may be performed by one or more computing systems, such as a computing system that executes the worksite controller 106. FIG. 8, discussed further below, describes an example system architecture for such a computing system.

At block 702, the computing system may determine a shape of a work area 104 that is to be compacted. The computing system may have, or access, data defined by user input, a worksite plan, and/or other information that identifies locations of boundary points 120 surrounding the work area 104. Accordingly, based on defined locations of the boundary points 120 associated with the work area 104, the computing system may determine the length and orientation of segments 122 that span between pairs of boundary points 120, identify distinct edges of the work area 104, and/or otherwise determine the boundaries and overall shape of the work area 104.

At block 704, the computing system may determine whether the work area 104 has a regular shape. For example, the computing system may determine that the work area 104 has a regular shape if the shape of the work area 104 is a rectangle, square, or other regular shape that has a straight edge with at least a threshold length. If the computing system determines that the shape of the work area 104 is regular (Block 704—Yes), the computing system may generate a series of straight paths 110 through the work area 104 that separated by intervals and are oriented along a fixed direction. For instance, the fixed direction of the paths 110 may be a direction along which a straight edge of the work area 104 is oriented, for example as shown in FIG. 2.

However, if the computing system instead determines that the work area 104 has an irregular shape (Block 704—No), the computing system may identify candidate model edges of the work area 104 at block 708. The candidate model edges may be edges that could be used as the model edge 126 during generation of paths 110 for the compaction machine 102. For example, the computing system may, based on the boundary points 120 of the work area 104, identity distinct edges of the work area 104. The computing system may also determine lengths of the distinct edges of the work area 104, and may identify the candidate model edges by identifying edges of the work area 104 that are longer than other edges of the work area 104. For example, the computing system may be configured to identify the two longest edges of the work area 104 as candidates to be the model edge 126.

At block 710, the computing system may select the model edge 126, from among the candidate model edges identified at block 708, based on identifying which of the candidate model edges is the smoothest. The computing system may evaluate the smoothness of a candidate model edge by determining directions along which individual segments 122 of the candidate model edge are oriented, and by determining difference angles 124 between adjacent segments 122 of the candidate model edge.

In some examples, the computing system determine a sum or other overall measure of the difference angles 124 associated with the boundary points 120 of each of the candidate model edges. In these examples, the computing system may determine which of the candidate model edges is the smoothest, and should be used as the model edge 126, based on determining which of the candidate model edges is associated with the lowest overall difference angle 124.

The computing system may also determine whether difference angles 124 associated with individual boundary points 120 exceed a threshold angle 128. The threshold angle 128 may, for example, be based on an operational turning radius of the compaction machine 102. Accordingly, in some examples, the computing system may also, or alternately, determine which candidate model edges is the smoothest, and should be used as the model edge 126, based on determining which of the candidate model edges has the fewest boundary points 120 that are associated with difference angles 124 that exceed the threshold angle 128.

After selecting the model edge 126 at block 710, the computing system may determine at block 712 whether any of the boundary points 120 along the model edge 126 are associated with difference angles 124 that exceed the threshold angle 128. In some examples, the threshold angle 128 may be based on an operational turning radius of the compaction machine 102. Accordingly, at block 712 the computing system may determine whether the compaction machine 102 could travel along a path 110 shaped like the model edge 126 while performing compaction operations, without having to make turns at angles that exceed the operational turning radius of the compaction machine 102.

If the model edge 126 has any boundary points 120 associated with difference angles 124 that exceed the threshold angle 128 (Block 712—Yes), the computing device may smoothen the model edge 126 at block 714. For example, the computing system may add boundary points 120 to the model edge 126, and/or adjust the locations of original boundary points 120 along the model edge 126, such that none of the boundary points 120 along the modified model edge 126 are associated with difference angles 124 that exceed the threshold angle 128. Accordingly, at block 714 the computing system may smoothen out relatively sharp bends in the original shape of the model edge 126, that had difference angles 124 that exceeded the threshold angle 128, to create a smoothened model edge 126 with a shape that the compaction machine 102 could travel along without making turns at angles that exceed the operational turning radius of the compaction machine 102.

After smoothing the model edge 126 at block 714, or if the computing system determined that the original model edge 126 did not have any boundary points 120 associated with difference angles 124 that exceed the threshold angle 128 (Block 712—No) such that the computing system did not smooth the model edge 126 at block 714, the computing system may determine a path shape based on the shape of the model edge 126 at block 716. For example, if the computing system smoothed the model edge 126 at block 714, the computing system may determine the path shape by copying the smoothened shape of the model edge 126. If the computing system determined that the original model edge 126 did not have any boundary points 120 associated with difference angles 124 that exceed the threshold angle 128, such that the computing system did not smooth the model edge 126 at block 714, the computing system may determine the path shape by copying the original unmodified shape of the model edge 126.

At block 718, the computing system may generate paths 110 associated with the work area 104. The paths 110 may have the path shape determined at block 716 based on the shape of the model edge 126. The shape of the paths 110 may accordingly match the shape of the model edge 126. The computing system may position the paths 110, having the path shape determined at block 716, at intervals spanning across a width of the work area 104 from the model edge 126 towards an opposite edge of the work area 104.

At block 720, the computing system may transmit compaction instructions 108, identifying the paths 110 generated at block 706 or block 718, to the wireless communication interfaces 118 of the compaction machine 102. The ECM 114 of the compaction machine 102 may, based on the compaction instructions 108, cause the compaction machine 102 to autonomously or semi-autonomously travel along the paths 110 defined in the compaction instructions 108 while performing compaction operations. For example, the compaction machine 102 may travel along a first path 110 through the work area 104 defined in the compaction instructions 108 while performing compaction operations, may exit the work area 104 to reposition the compaction machine 102 to become in alignment with a second path 110 defined in the compaction instructions 108 that is adjacent to the first path 110, may travel along the second path 110 through the work area 104 while performing compaction operations, and may continue following additional paths 110 through the work area 104 defined in the compaction instructions 108 while performing compaction operations.

FIG. 8 is a schematic illustration depicting an exemplary architecture of a computing system 800 that executes one or more elements described in the present disclosure. The computing system 800 may include one or more processors 802, memory 804, and communication interfaces 806.

In some examples, the computing system 800 may be, or execute, the worksite controller 106 or other external systems that are separate and/or remote from the compaction machine 102. In some of these examples, the computing system 800 may be a local server or other local computing device that is physically present at or near the worksite 100. In other examples, the computing system 800 may be a remote server or other remote computing system that is located at a remote location relative to the worksite 100. For instance, the computing system 800 may be executed via a remote server, a cloud computing environment, or other computing system that is not present at the worksite 100.

In other examples, the computing system 800 may be the ECM 114 and/or another computing system that is on-board the compaction machine 102. For example, the ECM 114 may be an instance of the computing system 800 that is configured to perform local operations on-board the compaction machine 102, such as operations that interpret compaction instructions 108 received from the worksite controller 106 and/or that cause the compaction machine 102 to autonomously or semi-autonomously travel along paths 110 defined in the compaction instructions 108 while performing compaction operations.

The processor(s) 802 of the computing system 800 may operate to perform a variety of functions as set forth herein. The processor(s) 802 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 802 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 802 may also access content and computer-executable instructions stored in the memory 804, and execute such computer-executable instructions.

The memory 804 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 802 to perform the operations described herein.

For example, the memory 804 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 802 and/or communication interface(s) 806 during execution thereof by the computing system 800. For example, the processor(s) 802 may possess local memory, which also may store program modules, program data, and/or one or more operating systems.

The memory 804 may store data and/or computer-executable instructions. For example, if the computing system 800 executes the worksite controller 106, the memory 804 may store data and/or computer-executable instructions associated with generation of paths 110 through a work area 104.

As an example, if the computing system 800 executes the worksite controller 106, the memory 804 may store work area data 808. The work area data 808 may define locations of boundary points 120 associated with the work area 104, and/or may indicate other information associated with the work area 104.

As another example, the memory 804 may store data and/or computer-executable instructions associated with a path generator 810 that is configured to generate paths 110 associated with the work area 104 for the compaction machine 102. For example, the path generator 810 may use the work area data 808 to identify a model edge 126 of the work area 104, smooth the model edge 126 if the model edge 126 has boundary points 120 associated with difference angles 124 that exceed a defined threshold angle 128, and generate the paths 110 based on the shape of the original or smoothened model edge 126.

As another example, the memory 804 may also store data and/or computer-executable instructions associated with a compaction instruction generator 812. The compaction instruction generator 812 may be configured to generate compaction instructions 108 that define the shapes and/or locations of the paths 110 generated by the work area data 808, and to cause the computing system 800 to transmit the compaction instructions 108 to the wireless communication interfaces 118 of the compaction machine 102.

The memory 804 may also store other modules and data 814 that may be utilized by the computing system 800 to perform or enable performing any action taken by the computing system 800. For example, the other modules and data 814 may include a platform, operating system, and/or applications, as well as data utilized by the platform, operating system, and/or applications.

The communication interfaces 806 may include transceivers, modems, interfaces, antennas, and/or other components that may transmit and/or receive data over networks or other data connections. In examples in which the computing system 800 executes the worksite controller 106, the worksite controller 106 may use the communication interfaces 806 to transmit the compaction instructions 108 to the wireless communication interfaces 118 of the compaction machine 102. In other examples in which the computing system 800 is the ECM 114 of the compaction machine 102, the communication interfaces 806 may be the wireless communication interfaces 118 of the compaction machine 102.

### INDUSTRIAL APPLICABILITY

As described herein, the worksite controller 106 may generate paths 110 through a work area 104 that a compaction machine 102 may travel along while performing compaction operations to compact a surface of the work area 104. The worksite controller 106 may identify a model edge 126 of the work area 104, smoothen the model edge 126 if the model edge 126 includes one or more boundary points 120 associated with difference angles 124 greater than a threshold angle 128, and may determine a shape of the paths 110 modeled after the shape of the model edge 126. The worksite controller 106 may position a series of paths 110 at intervals spanning across a width of the work area 104, with individual paths 110 having the shape modeled after the shape of the model edge 126.

Accordingly, if the model edge 126 is not straight, the paths 110 generated by the worksite controller 106 may be non-straight paths 110. The worksite controller 106 may transmit compaction instructions 108 that cause the compaction machine 102 to autonomously or semi-autonomously travel along the paths 110, generated by the worksite controller 106, while the compaction machine 102 performs compaction operations to compact a surface of the work area 104.

As an example, because the shape a first path 110 adjacent to the model edge 126 may have the same non-straight shape as the model edge 126, the compaction machine 102 may stay substantially immediately next to the non-straight model edge 126 throughout travel along the first path 110. When the compaction machine 102 then travels along a non-straight second path 110 that is adjacent to the first path 110 and has the same non-straight shape as the first path 110, the compaction machine 102 may stay substantially immediately next to a non-straight portion of the work area 104 that the compaction machine 102 already compacted during travel along the first path 110.

In some examples, if a work area 104 has a rectangular shape or other regular shape, a series of parallel straight paths may allow the compaction machine 102 to compact the surface of the entire work area 104. However, in many situations, a work area 104 may have an irregular shape, for instance because boundary points 120 have been defined along non-straight edges of the work area 104 based on locations of access roads, obstacles, terrain features, operations of other machines near the work area 104, and/or other concerns. In such situations, non-straight paths 110 through an irregularly-shaped work area 104, determined by the worksite controller 106 as described herein, may increase efficiency of the compaction machine 102 relative to a series of parallel straight paths.

For example, when a work area 104 has an irregular shape, non-straight paths 110 or straight paths may potentially allow the compaction machine 102 to travel through, and compact the surface of, the entirety of the irregularly-shaped work area 104. However, the number of non-straight paths 110 needed for the compaction machine 102 to fully cover the entirety of the irregularly-shaped work area 104 may be less than the number of straight paths needed for the compaction machine 102 to fully cover the entirety of the irregularly-shaped work area 104. Accordingly, because the number of non-straight paths 110 that fully cover the irregularly-shaped work area 104 may be lower than the number of straight paths that would fully cover the same irregularly-shaped work area 104, the number of paths 110 that the compaction machine 102 follows while performing compaction operations at the work area 104 may be reduced.

As an example, as discussed above with respect to FIG. 3, non-straight paths 110 determined based on the shape of the model edge model edge 126 of the second work area 302 may cause the compaction machine 102 to travel into, and compact the surface of, the outcropping 316 of the second work area 302, as well as cause the compaction machine 102 to avoid traveling into the external area 318 outside the second work area 302. As an example, a series of four non-straight paths 110, modeled after the model edge 126, of the second work area 302 may allow the compaction machine 102 to compact the surface of the entire second work area 302 as shown in FIG. 3.

However, if the paths 110 associated with the second work area 302 were instead generated as parallel straight paths that are each oriented along a predefined direction and are not modeled after the shape of the model edge 126, a similar series of four parallel straight paths may not allow the compaction machine 102 to compact the surface of the entire second work area 302. For example, a series of four parallel straight paths extending between the fourth edge 310 and the second edge 306 of the second work area 302 may cause the compaction machine 102 to miss traveling through, and compacting the surface of, the outcropping 316 of the second work area 302. Such a series of four parallel straight paths may also cause the compaction machine 102 to travel into the external area 318 that is outside the second work area 302. To cause the compaction machine 102 to fully travel through and compact the surface of all portions of the second work area 302, additional parallel straight paths may be needed. For example, one or more additional parallel straight paths, having shorter lengths than a length from the fourth edge 310 to the second edge 306, may extend through the outcropping 316. As another example, additional parallel straight paths may extend from the fourth edge 310 to a first boundary of the external area 318, and from a second boundary of the external area 318 to the second edge 306, to thereby avoid having a longer straight path extend through the external area 318.

Accordingly, although more than four parallel straight paths may allow the compaction machine 102 to fully cover the second work area 302, a series of four non-straight paths 110 with shapes modeled after the shape of the model edge 126 of the second work area 302 may allow the compaction machine 102 to fully cover the second work area 302. Accordingly, the compaction machine 102 may make four passes through the second work area 302 by following those four non-straight paths 110, instead of making a larger number of passes through the second work area 302 by following a larger number of straight paths.

Because the compaction machine 102 may make fewer passes through an irregularly-shaped work area 104 by following non-straight paths 110 modeled after a model edge 126 of the irregularly-shaped work area 104, rather than following a larger number of parallel straight paths oriented along a single predefined direction, the compaction machine 102 may compact the surface of the work area 104 more quickly and/or by performing fewer operations. The compaction machine 102 may accordingly also consume less fuel and/or battery power during operations at the work area 104, reduce maintenance of the compaction machine 102, prolong a lifespan of the compaction machine 102, and/or experience other benefits.

As an example, at an end of a path 110 associated with a work area 104, the compaction machine 102 may slow down, stop, or otherwise adjust the operations of the compaction components 112, may exit the work area 104 and perform driving maneuvers to realign the compaction machine 102 with the next adjacent path 110, and may resume full operations of the compaction components 112 and begin traveling along the next adjacent path 110. However, by modeling the shape of the paths 110 based on a non-straight model edge 126 of the work area 104 as described herein, there may be smaller number of paths 110 associated with the work area 104 overall relative to having a larger number of straight paths oriented along a predefined direction.

Accordingly, by reducing the number of path 110 the compaction machine 102 is assigned to travel while operating at the work area 104, the compaction machine 102 perform operations to transition between paths 110 a fewer number of times. For example, rather than starting and stopping the compaction components 112 and performing repositioning maneuvers during transitions between six different straight paths, the compaction machine 102 may instead only start and stop the compaction components 112 and perform repositioning maneuvers during transitions between four different non-straight paths 110 modeled after a model edge 126 of the work area 104. Performing such operations and maneuvers a fewer amount of times, due to using non-straight paths 110 modeled after a model edge 126 of the work area 104, may prolong the lifespan of the compaction components 112 and/or other elements of the compaction machine 102, may reduce or delay maintenance of the compaction components 112 and/or other elements of the compaction machine 102, may reduce energy consumption of the compaction machine 102, and/or may lead to other benefits and efficiencies. Moreover, by traveling through a fewer number of non-straight paths 110, relative to a higher number of straight paths to cover the same work area 104, the compaction machine 102 may consume less energy and/or complete compaction operations at the work area more quickly overall.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A computer-implemented method, comprising:
determining, by a computing system comprising a processor, boundary points defining boundaries of a work area with a surface to be compacted by a compaction machine;
determining, by the computing system, edges of the work area based on the boundary points;
selecting, by the computing system, a model edge from among the edges;
generating, by the computing system, a series of paths positioned at intervals across a width of the work area, wherein individual paths, of the series of paths, have path shapes modeled after a shape of the model edge; and
sending, by the computing system, compaction instructions defining the series of paths, wherein the compaction instructions cause the compaction machine to autonomously travel along the series of paths while performing compaction operations to compact the surface of the work area.

2. The computer-implemented method of claim 1, wherein selecting the model edge comprises:
identifying, by the computing system, candidate model edges that are longer than one or more shorter edges of the edges;
determining, by the computing system, difference angles between directions along which segments of the candidate model edges, that meet at corresponding boundary points, are aligned;
determining, by the computing system, a smoothest candidate model edge based at least in part on the difference angles that correspond to the candidate model edges; and
selecting, by the computing system, the smoothest candidate model edge as the model edge.

3. The computer-implemented method of claim 2, wherein the computing system determines the smoothest candidate model edge by:
determining, based on the difference angles, overall difference angles associated with the candidate model edges; and
selecting a candidate model edge, of the candidate model edges, that is associated with a lowest overall difference angle as the smoothest candidate model edge.

4. The computer-implemented method of claim 2, wherein the computing system determines the smoothest candidate model edge by:
identifying numbers of the boundary points, along the candidate model edges, that are associated with corresponding difference angles that exceed a threshold angle; and
selecting a candidate model edge, of the candidate model edges, that is associated with a lowest number of the boundary points that are associated with the corresponding difference angles that exceed the threshold angle as the smoothest candidate model edge.

5. The computer-implemented method of claim 1, further comprising:
determining, by the computing system, difference angles between directions along which segments of the model edge, that meet at corresponding boundary points, are aligned;
determining, by the computing system, that at least one of the boundary points on the model edge is associated with a difference angle that exceeds a threshold angle; and
smoothing, by the computing system, the model edge by adding or adjusting at least one boundary point associated with the model edge to cause none of the difference angles associated with the boundary points on the model edge to exceed the threshold angle.

6. The computer-implemented method of claim 5, wherein the threshold angle corresponds with an operational turning radius of the compaction machine defining a maximum angle at which the compaction machine is configured to turn while performing the compaction operations.

7. The computer-implemented method of claim 1, wherein:
the shape of the model edge is non-straight, and
the path shapes, modeled after the shape of the model edge, are non-straight.

8. The computer-implemented method of claim 1, further comprising:
determining, by the computing system, and based on the boundary points, that the work area has an irregular shape;
wherein the computing system selects the model edge and generates the individual paths, with the path shapes modeled after the shape of the model edge, based on determining that the work area has the irregular shape.

9. A computing system, comprising:
a processor; and
a memory having stored thereon computer-executable instructions that, when executed by the processor, cause the processor to:
determine boundary points defining boundaries of a work area with a surface to be compacted by a compaction machine;
determine edges of the work area based on the boundary points;
select a model edge from among the edges;
generate a series of paths positioned at intervals across a width of the work area, wherein individual paths, of the series of paths, have path shapes modeled after a shape of the model edge; and
send compaction instructions defining the series of paths, wherein the compaction instructions cause the compaction machine to autonomously travel along the series of paths while performing compaction operations to compact the surface of the work area.

10. The computing system of claim 9, wherein the computer-executable instructions cause the processor to select the model edge by:
identifying candidate model edges that are longer than one or more shorter edges of the edges;
determining difference angles between directions along which segments of the candidate model edges, that meet at corresponding boundary points, are aligned;
determining a smoothest candidate model edge based at least in part on the difference angles that correspond to the candidate model edges; and
selecting the smoothest candidate model edge as the model edge.

11. The computing system of claim 9, wherein the computer-executable instructions cause the processor to:
determine difference angles between directions along which segments of the model edge, that meet at corresponding boundary points, are aligned;
determine that at least one of the boundary points on the model edge is associated with a difference angle that exceeds a threshold angle; and
smoothing the model edge by adding or adjusting at least one boundary point associated with the model edge to cause none of the difference angles associated with the boundary points on the model edge to exceed the threshold angle.

12. The computing system of claim 11, wherein the threshold angle corresponds with an operational turning radius of the compaction machine defining a maximum angle at which the compaction machine is configured to turn while performing the compaction operations.

13. The computing system of claim 9, wherein:
the shape of the model edge is non-straight, and
the path shapes, modeled after the shape of the model edge, are non-straight.

14. The computing system of claim 9, wherein the computer-executable instructions cause the processor to:
determine, based on the boundary points, that the work area has an irregular shape; and
select the model edge and generate the individual paths, with the path shapes modeled after the shape of the model edge, based on determining that the work area has the irregular shape.

15. A system, comprising:
a compaction machine comprising:
a compaction component configured to perform compaction operations to compact a surface of a work area at a worksite;
a wireless communication interface configured to receive compaction instructions defining paths within the work area; and
an electronic control module configured to, based on the compaction instructions, cause the compaction machine to autonomously travel along the paths while the compaction machine performs the compaction operations; and
a worksite controller, associated with the worksite, comprising:
a processor; and
a memory having stored thereon computer-executable instructions that, when executed by the processor, cause the processor to:
determine boundary points defining boundaries of the work area;
determine edges of the work area based on the boundary points;
select a model edge from among the edges;
generate the paths, within the work area, based on a path shape modeled after a shape of the model edge; and
cause the worksite controller to send the compaction instructions to the wireless communication interface of the compaction machine.

16. The system of claim 15, wherein the computer-executable instructions cause the processor to select the model edge by:
identifying candidate model edges that are longer than one or more shorter edges of the edges;
determining difference angles between directions along which segments of the candidate model edges, that meet at corresponding boundary points, are aligned;
determining a smoothest candidate model edge based at least in part on the difference angles that correspond to the candidate model edges; and
selecting the smoothest candidate model edge as the model edge.

17. The system of claim 15, wherein the computer-executable instructions cause the processor to:
determine difference angles between directions along which segments of the model edge, that meet at corresponding boundary points, are aligned;
determine that at least one of the boundary points on the model edge is associated with a difference angle that exceeds a threshold angle; and
smoothing the model edge by adding or adjusting at least one boundary point associated with the model edge to cause none of the difference angles associated with the boundary points on the model edge to exceed the threshold angle.

18. The system of claim 17, wherein:
the threshold angle corresponds with an operational turning radius of the compaction machine, and
the operational turning radius is a maximum angle at which the compaction machine is configured to turn while traveling and performing the compaction operations via the compaction component.

19. The system of claim 15, wherein:
the shape of the model edge is non-straight, and
the path shape, modeled after the shape of the model edge, is non-straight.

20. The system of claim 15, wherein the computer-executable instructions cause the processor to:
determine, based on the boundary points, that the work area has an irregular shape; and
select the model edge and generate the paths, with the path shape modeled after the shape of the model edge, based on determining that the work area has the irregular shape.
